(19) United States
(12) Patent Application Publication
(10) Pub. No.: US 2022/0207165 A1
(43) Pub. Date: Jun. 30, 2022

(54) INFORMATION PROCESSING METHOD, SYSTEM, ELECTRONIC DEVICE AND COMPUTER READABLE STORAGE MEDIUM

(71) Applicants: UNIORANGE INTERNET DESIGN CO., LTD., Yantai (CN); BEIJING UNIORANGE TECHNOLOGY CO., LTD., Beijing (CN)

(72) Inventors: Jiadong PAN, Yantai (CN); Hongjie SHEN, Beijing (CN); Yingfang ZHAO, Yantai (CN); Feng WU, Beijing (CN); Jinlin XIE, Beijing (CN); Zenghua ZHANG, Yantai (CN); Xiaoxue HAN, Yantai (CN); Xiangyuan JI, Beijing (CN); Yang SHI, Beijing (CN); Yunlei MA, Beijing (CN)

(73) Assignees: UNIORANGE INTERNET DESIGN CO., LTD., Yantai (CN); BEIJING UNIORANGE TECHNOLOGY CO., LTD., Beijing (CN)

(21) Appl. No.: 17/220,037

(22) Filed: Apr. 1, 2021

(30) Foreign Application Priority Data
Dec. 31, 2020 (CN) 202011626855.7

(51) Int. Cl. G06F 21/62

(52) U.S. Cl. CPC G06F 21/6209

(57) ABSTRACT

An information processing method, an information processing system, an electronic device, and a computer readable storage medium are provided. The information processing method is applied to a server. The method includes: in response to receiving first import operation information performed by a first account on the design application, synchronizing the electronic file generated by the design application to the first work subspace by using the first plug-in; in response to a second account having first permission to access the first work subspace, receiving a first access request from the second account for accessing the electronic file through the first work subspace; and in response to the second account having second permission to access the electronic file, responding to the first access request. The method can allow a plurality of users to collaborate online, and improve the efficiency of collaboration of the plurality of users.

### CROSS-REFERENCE

The present application claims priority of the Chinese Patent Application No. 202011626855.7, filed on Dec. 31, 2020. For all purposes under the U.S. law, the entire disclosure of the aforementioned application is incorporated by reference as part of the disclosure of this application.

### TECHNICAL FIELD

Embodiments of the present disclosure relate to an information processing method, an information processing system, an electronic device, and a computer readable storage medium.

### BACKGROUND

In the research and development process of complex industrial products, research and development teams organized across enterprises or across regions need to conduct collective collaboration and joint research and development when solving technical problems and confirming follow-up work. Enterprise research and development personnel sometimes not only need to share and collaborate among internal members, but also need to conduct activities such as research and development data exchange, program review and technology communication with collaborative members outside the enterprise (e.g., experts, customers, suppliers, etc.).

### SUMMARY

At least one embodiment of the present disclosure provides an information processing method which is applied to a server. Work space and an application virtualization system are deployed on the server, a design application is deployed in the application virtualization system, the design application comprises a first plug-in, the work space at least comprises first work subspace, and the work space comprises a functional module that manages an electronic file generated based on the design application. The method comprises: in response to receiving first import operation information performed by a first account on the design application, synchronizing the electronic file generated by the design application to the first work subspace by using the first plug-in; in response to a second account having first permission to access the first work subspace, receiving a first access request from the second account for accessing the electronic file through the first work subspace; and in response to the second account having second permission to access the electronic file, responding to the first access request.

For example, in the information processing method provided by an embodiment of the present disclosure, the first access request is used for requesting to open the electronic file so as to operate the electronic file. In response to the second account having the second permission to access the electronic file, responding to the first access request, comprises: in response to the second account having the second permission to access the electronic file, activating the design application through the application virtualization system; and synchronizing the electronic file from the first work subspace to the design application by using the first plug-in, so that the second account opens the electronic file through the design application and operates the electronic file.

For example, in the information processing method provided by an embodiment of the present disclosure, a first account virtualization subsystem is deployed in the application virtualization system, the first account virtualization subsystem comprises a first management application of the first account with respect to the design application, and the design application further comprises a first management plug-in with respect to the first account. The method further comprises: in response to receiving first synchronization operation information, synchronizing the electronic file generated by the design application to the first management application by using the first management plug-in.

For example, in the information processing method provided by an embodiment of the present disclosure, a second account virtualization subsystem is deployed in the application virtualization system, the second account virtualization subsystem comprises a second management application with respect to the design application, and the design application further comprises a second management plug-in with respect to the second account. The method further comprises: in response to receiving second synchronization operation information, synchronizing the electronic file opened by the second account to the second management application by using the second management plug-in.

For example, in the information processing method provided by an embodiment of the present disclosure, the first management application stores the electronic file, and the method further comprises: in response to receiving first export operation information performed by the first account on the design application, synchronizing the electronic file in the first management application to the design application by using the first management plug-in.

For example, in the information processing method provided by an embodiment of the present disclosure, the work space further comprises second work subspace, and the method further comprises: in response to receiving second import operation information, synchronizing the electronic file to the second work subspace by using the first plug-in, so that the second work subspace comprises the electronic file that is operated.

For example, in the information processing method provided by an embodiment of the present disclosure, a portal website is deployed on the server, and the first account or the second account is capable of logging in to the portal website through a browser, so as to send the first access request to the server through the portal website.

For example, in the information processing method provided by an embodiment of the present disclosure, the portal website comprises an application center, the first account or the second account is capable of sending a second access request to the server through the application center, the application virtualization system comprises a shared virtualization subsystem, and the shared virtualization subsystem comprises the design application. The method further comprises: verifying identity information in response to receiving the second access request generated through the portal website, the second access request comprising the identity information; in the case where the identity information comprised in the second access request is verified, determining a virtualization subsystem to which the second access request is distributed according to the identity information, the virtualization subsystem comprising the first account virtualization subsystem, the second account virtualization subsystem, or the shared virtualization subsystem; and distributing the second access request to one of the first account virtualization subsystem, the second account virtualization subsystem, or the shared virtualization subsystem.

For example, in the information processing method provided by an embodiment of the present disclosure, the shared virtualization subsystem comprises a virtual application assistant. The method further comprises: verifying the identity information in response to receiving the first access request generated through the portal website, the first access request comprising the identity information; in the case where the identity information comprised in the first access request is verified, forwarding the first access request to the shared virtualization subsystem according to the identity information; and responding, by the virtual application assistant, to the first access request.

For example, the information processing method provided by an embodiment of the present disclosure further comprises: in response to receiving a creation request for creating a task in the first work subspace, creating the task in the first work subspace; receiving member permission information, so as to manage access permission of a member in the task to access the first work subspace or to access the electronic file of the task; and determining whether the second account has permission to access the first work subspace according to the member permission information.

For example, the information processing method provided by an embodiment of the present disclosure further comprises: receiving management operation information generated based on that the first account manages permission to access the electronic file; and determining whether the second account has the second permission according to the management operation information.

At least one embodiment of the present disclosure further provides an information processing method which is applied to a server. Work space and an application virtualization system are deployed on the server, the application virtualization system comprises a first account virtualization subsystem, the first account virtualization subsystem at least comprises a first management application, the first management application comprises a first management application adaptor and stores an electronic file, the work space comprises an interface program and first work subspace, and the work space comprises a functional module that manages the electronic file generated based on a design application. The method comprises: in response to receiving third synchronization operation information performed by a first account in the first work subspace, synchronizing the electronic file from the first management application to the first work subspace through the first management application adaptor via the interface program; in response to a second account having first permission to access the first work subspace, receiving a first access request from the second account to access the electronic file through the first work subspace; and in response to the second account having second permission to access the electronic file, responding to the first access request.

For example, in the information processing method provided by an embodiment of the present disclosure, the application virtualization system further comprises a second account virtualization subsystem, the second account virtualization subsystem at least comprises a second management application, the second management application comprises a second management application adaptor, and the work space further comprises second work subspace. The first access request comprises a first request for synchronizing the electronic file from the first work subspace to the second work subspace. In response to the second account having the second permission to access the electronic file, responding to the first access request, comprises: in response to the second account having the second permission to access the electronic file, synchronizing the electronic file to the second work subspace through the interface program and the second management application adaptor.

For example, in the information processing method provided by an embodiment of the present disclosure, a design application is deployed in the application virtualization system, the design application comprises a first plug-in, and the first access request further comprises a second request for opening the electronic file so as to operate the electronic file. In response to the second account having the second permission to access the electronic file, responding to the first access request, comprises: in response to the second account having the second permission to access the electronic file, activating the design application through the application virtualization system; and synchronizing the electronic file from the first work subspace to the design application by using the first plug-in, so that the second account opens the electronic file through the design application and operates the electronic file.

For example, in the information processing method provided by an embodiment of the present disclosure, a portal website is deployed on the server, and the first account or the second account is capable of logging in to the portal website through a browser, so as to send the first access request to the server through the portal website.

For example, in the information processing method provided by an embodiment of the present disclosure, the portal website comprises an application center, and the first account or the second account is capable of sending a second access request to the server through the application center. The method further comprises: receiving the second access request from the portal website, the second access request comprising identity information; verifying the identity information; in the case where the identity information is verified, determining a virtualization subsystem to which the second access request is distributed according to the identity information, the virtualization subsystem comprising the first account virtualization subsystem or the second account virtualization subsystem; and distributing the second access request to the first account virtualization subsystem or the second account virtualization subsystem.

For example, in the information processing method provided by an embodiment of the present disclosure, the application virtualization system comprises a shared virtualization subsystem, and the shared virtualization subsystem comprises the design application and a virtual application assistant. The method further comprises: receiving the first access request from the portal website, the first access request comprising identity information; verifying the identity information; in the case where the identity information is verified, forwarding the first access request to the shared virtualization subsystem according to the identity information; and activating, by the virtual application assistant, the design application.

For example, the information processing method provided by an embodiment of the present disclosure further comprises: in response to receiving a creation request for creating a task in the first work subspace, creating the task in the first work subspace; receiving member permission information so as to manage permission of members in the task to access the first work subspace or to access the electronic file of the task; and determining whether the second account has permission to access the first work subspace according to the member permission information.

For example, the information processing method provided by an embodiment of the present disclosure further comprises: receiving management operation information generated base on that the first account manages permission to access the electronic file; and determining whether the second account has the second permission according to the management operation information.

At least one embodiment of the present disclosure further provides an information processing system which comprises a server. Work space and an application virtualization system are deployed on the server, a design application is deployed in the application virtualization system, the design application comprises a first plug-in, the work space at least comprises first work subspace created for a first account, and the work space comprises a functional module that manages an electronic file generated based on the design application. The first work subspace is configured to, in response to a second account having first permission to access the first work subspace, receive a first access request from the second account for accessing the electronic file through the first work subspace; the design application is configured to receive first import operation information performed by the first account on the design application, and respond to the first access request in response to the second account having second permission to access the electronic file; and the first plug-in is configured to synchronize the electronic file generated by the design application to the first work subspace.

At least one embodiment of the present disclosure further provides an information processing system which comprises a server. Work space and an application virtualization system are deployed on the server, the application virtualization system comprises a first account virtualization subsystem, the first account virtualization subsystem at least comprises a first management application, the first management application comprises a first management application adaptor and an electronic file, the work space comprises an interface program and first work subspace created for a first account, and the work space comprises a functional module that manages the electronic file generated based on the design application. The first management application adaptor is configured to send the electronic file to the interface program in response to receiving third synchronization operation information performed by the first account in the first work subspace; the interface program is configured to receive the electronic file sent from the first management application adaptor, so as to synchronize the electronic file to the first work subspace; and the first work subspace is configured to receive a first access request from a second account to access the electronic file through the first work subspace in response to the second account having first permission to access the first work subspace, and respond to the first access request in response to the second account having second permission to access the electronic file.

At least one embodiment of the present disclosure further provides an electronic device, which comprises a processor and a memory. The memory comprises one or more computer program modules. The one or more computer program modules are stored in the memory and configured to be executed by the processor, and the one or more computer program modules comprise instructions for implementing the information processing method provided by any one of the embodiments of the present disclosure.

At least one embodiment of the present disclosure further provides a computer readable storage medium, for storing non-transitory computer readable instructions. The non-transitory computer readable instructions are configured to be executed by a computer to implement the information processing method provided by any one of the embodiments of the present disclosure.

### BRIEF DESCRIPTION OF THE DRAWINGS

In order to clearly illustrate the technical solution of the embodiments of the present disclosure, the drawings of the embodiments will be briefly described in the following. It is obvious that the described drawings in the following are only related to some embodiments of the present disclosure and thus are not limitative of the present disclosure.

FIG. 1A illustrates a flow chart of an information processing method provided by at least one embodiment of the present disclosure;

FIG. 1B illustrates a server cluster to which the information processing method provided by at least one embodiment of the present disclosure may be applied;

FIG. 1C illustrates a schematic diagram of an information processing method provided by at least one embodiment of the present disclosure;

FIG. 2A illustrates a flow chart of step S130 in FIG. 1A provided by at least one embodiment of the present disclosure;

FIG. 2B illustrates a schematic diagram of another information processing method provided by at least one embodiment of the present disclosure;

FIG. 3 illustrates a flow chart of another information processing method provided by at least one embodiment of the present disclosure;

FIG. 4 illustrates a flow chart of another information processing method provided by at least one embodiment of the present disclosure;

FIG. 5A illustrates another server cluster 500 to which the information processing method provided by at least one embodiment of the present disclosure may be applied;

FIG. 5B illustrates a flow chart of another information processing method provided by at least one embodiment of the present disclosure;

FIG. 5C illustrates a flow chart of another information processing method provided by at least one embodiment of the present disclosure;

FIG. 6 illustrates a flow chart of another information processing method provided by at least one embodiment of the present disclosure;

FIG. 7 illustrates a schematic diagram of another information processing method provided by at least one embodiment of the present disclosure;

FIG. 8A illustrates a schematic block diagram of an information processing system provided by at least one embodiment of the present disclosure;

FIG. 8B illustrates a schematic block diagram of another information processing system provided by at least one embodiment of the present disclosure;

FIG. 8C illustrates a schematic block diagram of an electronic device provided by at least one embodiment of the present disclosure;

FIG. 8D illustrates a schematic block diagram of another electronic device provided by at least one embodiment of the present disclosure; and

FIG. 9 illustrates a schematic diagram of a computer readable storage medium provided by at least one embodiment of the present disclosure.

### DETAILED DESCRIPTION

In order to make objects, technical details and advantages of the embodiments of the disclosure apparent, the technical solutions of the embodiments will be described in a clearly and fully understandable way in connection with the drawings related to the embodiments of the disclosure. Apparently, the described embodiments are just a part but not all of the embodiments of the disclosure. Based on the described embodiments herein, those skilled in the art can obtain other embodiment(s), without any inventive work, which should be within the scope of the disclosure.

Unless otherwise defined, all the technical and scientific terms used herein have the same meanings as commonly understood by one of ordinary skill in the art to which the present disclosure belongs. The terms “first”, “second”, etc., which are used in the description and the claims of the present application for disclosure, are not intended to indicate any sequence, amount or importance, but distinguish various components. The terms “comprise”, “comprising”, “include”, “including”, etc., are intended to specify that the elements or the objects stated before these terms encompass the elements or the objects and equivalents thereof listed after these terms, but do not preclude the other elements or objects. The phrases “connect”, “connected”, “coupled”, etc., are not intended to define a physical connection or mechanical connection, but may include an electrical connection, directly or indirectly. “On”, “under”, “right”, “left” and the like are only used to indicate relative position relationship, and when the position of the object which is described is changed, the relative position relationship may be changed accordingly.

An enterprise usually has its own product data management (PDM) system or product lifecycle management (PLM) system, which usually adopts a private cloud deployment solution. The cross-regional subsidiary usually adopts a dedicated line to implement an intranet environment, resulting in high costs, and log in cannot be realized outside the intranet environment. Even if the enterprise adopts a public cloud deployment solution, the user outside the enterprise usually cannot perform log in. Research and development personnel between different enterprises usually interact via emails or other communication tools, and the entire interaction process cannot be controlled by the enterprises. When data is exchanged between different enterprises, because the exchanged data does not have a unified format and attribute field requirements, the enterprise research and development personnel who receive the data need to perform format conversion, re-maintain attribute information, and so on, which greatly increases work time and reduces work efficiency. It can be seen that efficiency of communication and collaboration between personnel across organizations or across regions is low. At present, both efficiency of collaboration among internal research and development personnel and efficiency of collaboration between internal research and development personnel and external research and development personnel are relatively low.

At least one embodiment of the present disclosure provides an information processing method, an information processing system, an electronic device, and a computer readable storage medium. The information processing method is applied to a server, on which work space and an application virtualization system are deployed. A design application is displayed in the application virtualization system, the design application includes a first plug-in, the work space at least includes first work subspace, and the work space includes a functional module that manages an electronic file generated based on the design application. The method includes: in response to receiving first import operation information performed by a first account on the design application, synchronizing the electronic file generated by the design application to the first work subspace by using the first plug-in; in response to a second account having first permission to access the first work subspace, receiving a first access request from the second account for accessing the electronic file through the first work subspace; and responding to the first access request in response to the second account having second permission to access the electronic file. The information processing method may allow a plurality of users to collaborate online, and improve efficiency of collaboration between personnel across organizations or across regions. In addition, the information processing method allows a user to use a cloud-installed design application without installing a design application on a local terminal, thereby reducing project development costs and improving convenience of collaborative research and development.

At least one embodiment of the present disclosure provides another information processing method. The information processing method is applied to a server, on which work space and an application virtualization system are deployed. The application virtualization system includes a first account virtualization subsystem, the first account virtualization subsystem at least includes a first management application, and the first management application includes a first management application adaptor and stores an electronic file. The work space includes an interface program and first work subspace, and the work space includes a functional module that manages the electronic file generated based on a design application. The method includes: in response to receiving third synchronization operation information performed by a first account in the first work subspace, synchronizing the electronic file from the first management application to the first work subspace through the first management application adaptor via the interface program; in response to a second account having first permission to access the first work subspace, receiving a first access request from the second account for accessing the electronic file through the first work subspace; and responding to the first access request in response to the second account having second permission to access the electronic file. The information processing method may allow a plurality of users to collaborate online, and can improve efficiency of collaboration between personnel across organizations or across regions.

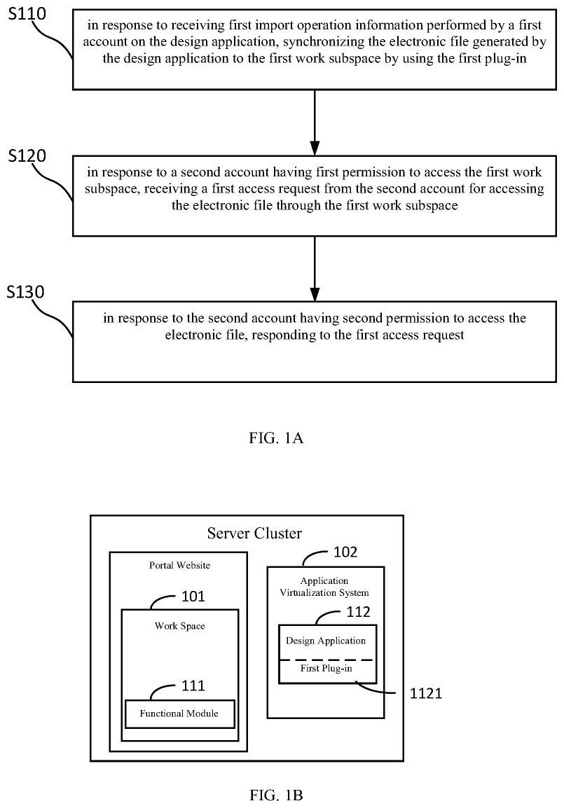

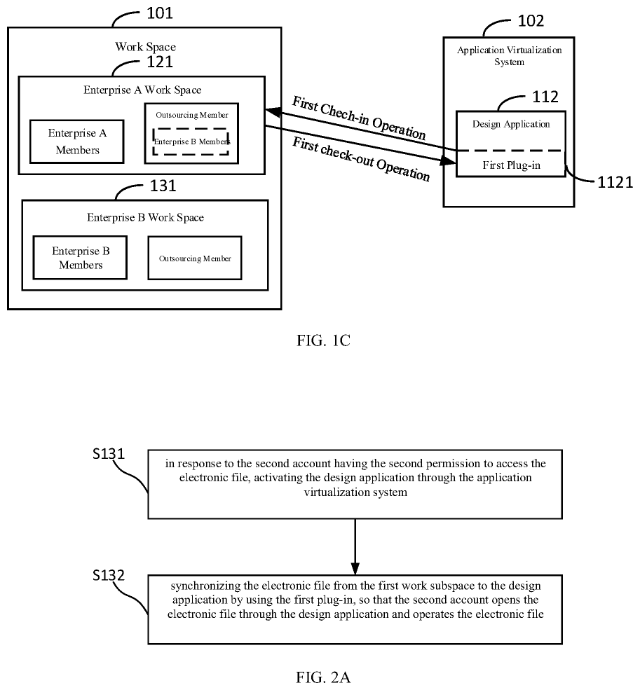

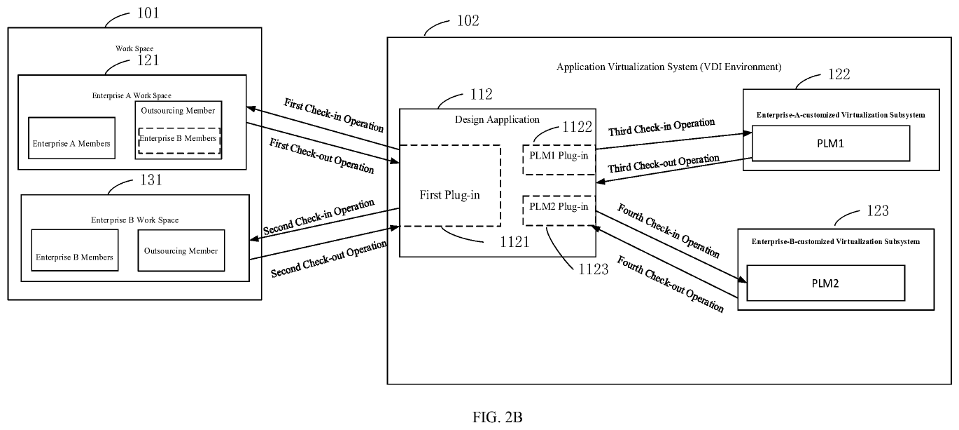

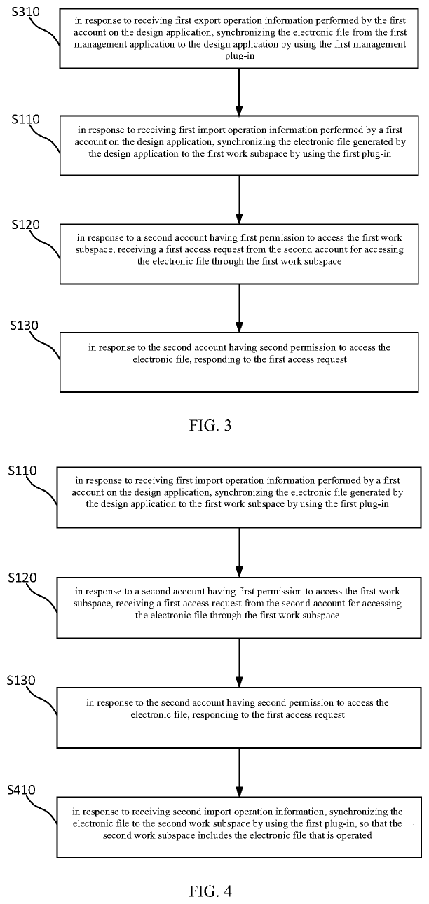

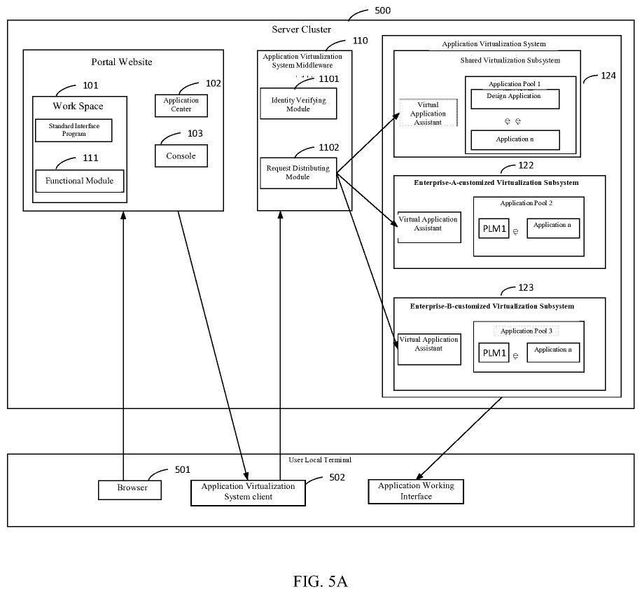

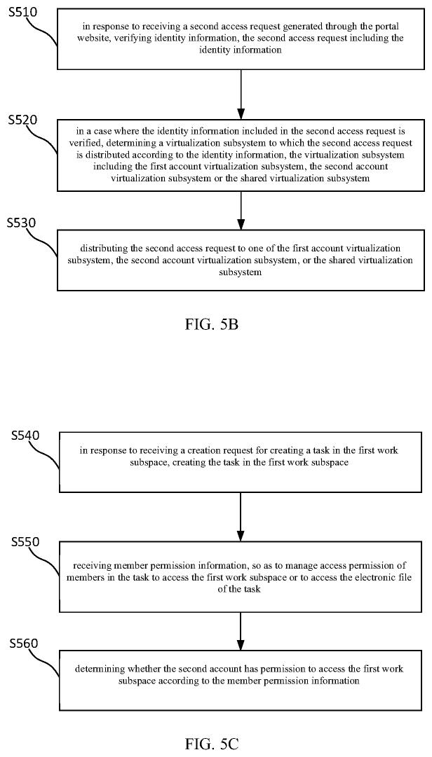

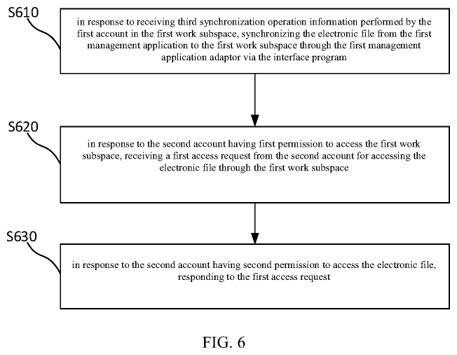

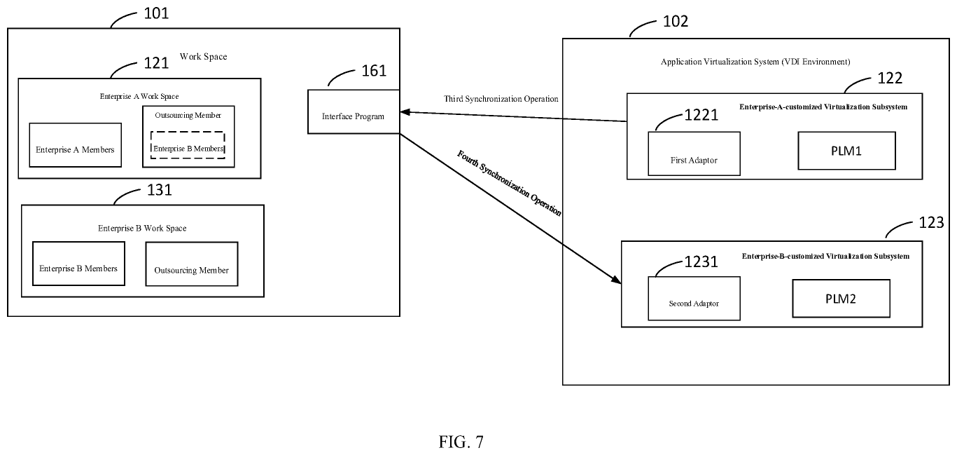

Hereinafter, an information processing method provided by at least one embodiment of the present disclosure is described with reference to FIG. 1A to FIG. 1C, FIG. 2A to FIG. 2B, FIG. 3 to FIG. 4, and FIG. 5A to FIG. 5C. Another information processing method provided by at least one embodiment of the present disclosure is described with reference to FIG. 6 to FIG. 7.

FIG. 1A illustrates a flow chart of an information processing method provided by at least one embodiment of the present disclosure.

As illustrated in FIG. 1A, the method may include steps S110 to S130. The method is applied to a server, on which work space and an application virtualization system are deployed. A design application is deployed in the application virtualization system, the design application includes a first plug-in, the work space at least includes first work subspace, and the work space includes a functional module that manages the electronic file generated based on the design application.

Step S110: in response to receiving first import operation information performed by a first account on the design application, synchronizing the electronic file generated by the design application to the first work subspace by using the first plug-in.

Step S120: in response to a second account having first permission to access the first work subspace, receiving a first access request from the second account for accessing the electronic file through the first work subspace.

Step S130: in response to the second account having second permission to access the electronic file, responding to the first access request.

In the information processing method, the electronic file can be synchronized to the first work subspace, and on the premise that other accounts have permission to access the first work subspace, the other accounts may access the electronic file through the first work subspace, so that a plurality of different accounts may interact with each other to exchange the electronic file through the first work subspace, which improves efficiency of collaboration among different accounts.

It should be noted that, unless otherwise specified, “import” and “export” herein may be respectively understood as concepts of “check in” and “check out” in PDM or PLM. For example, “import” may be understood as the concept of “check in” in PDM, that is, the electronic file is synchronized from one storage medium to another storage medium.

It should be understood that the above-described server may be a server cluster, or may be a single server. The present disclosure does not limit the server to be a single server, and the server may be a server cluster. Hereinafter, the embodiments of the present disclosure are described by taking a server cluster as an example.

FIG. 1B illustrates a server cluster to which the information processing method provided by at least one embodiment of the present disclosure may be applied.

As illustrated in FIG. 1B, work space 101 and an application virtualization system 102 are deployed on the server cluster.

A design application 112 is deployed in the application virtualization system 102, and the design application 112 includes a first plug-in 1121.

The application virtualization system 102 may be, for example, a virtual desktop infrastructure (VDI) environment based on a VDI. The VDI environment may include, for example, various design applications, operating systems, server management systems, user management systems, etc. It should be understood that the VDI environment may not only include the above-described various software, but also include hardware, for example, a server running a Linux system, a server running a window system, and so on.

The design application 112, for example, may include, but is not limited to, various applications for simulation, rendering, drawing, and design. The first plug-in 1121 may be, for example, a program with check-in and check-out functions, and serves as an interface between the design application 112 and the work space 101. For example, by using the first plug-in 1121, the electronic file generated by the design application 112 may be synchronized to the first work subspace, or the electronic file may be synchronized from the first work subspace to the design application 112.

The first plug-in 1121, for example, may be integrated in the design application 112, and the first plug-in 1121, for example, may have an icon provided on an interactive interface of the design application 112, so that the user may click on the icon to trigger the first plug-in 1121 to execute a check-in operation or a check-out operation. For example, the first plug-in 1121 may also be a program independent of the design application 112, an icon may be provided on the interactive interface of the design application 112, and when the user clicks on the icon, the first plug-in 1121 may be called to execute a check-in operation or a check-out operation.

As illustrated in FIG. 1B, a portal website is deployed on the server cluster, and a user may log in to the portal website through a browser so as to send an access request to the server through the portal website. The work space 101 may be deployed in the portal website.

The work space 101 includes a functional module 111 that manages the electronic file generated based on the design application 112. For example, the work space 101 may have a portion of the functional modules in the PDM, so as to use the portion of the functional modules to manage the electronic file.

For example, the electronic file may be a CAD file generated based on a CAD application, and the work space may include a functional module 111 that manages the CAD file. Of course, the embodiments of the present disclosure are not limited thereto, and the electronic file may be a file generated by any application, which is not limited to CAD, and may be determined according to actual needs.

The work space at least includes first work subspace, and the first work subspace, for example, may be work space created by the server cluster for the first account. The first work subspace, for example, may include a development project related to the first account. The work space, for example, may also include second work subspace, third work subspace, etc., which is respectively created for different accounts. The PDM functional module provided by the work space may be shared by a plurality of accounts, that is, the plurality of accounts may use the PDM functional module provided by the work space to manage the respective development projects. However, data or electronic files in the work subspace (the first work subspace, the second work subspace, etc.) created for the respective accounts may be isolated. For example, the work subspace created for the respective accounts may be physically isolated or logically isolated.

Hereinafter, the embodiments of the present disclosure are described by taking that the design application 112 is a CAD application and the electronic file is a CAD file as an example, but this does not constitute a limitation to the embodiments of the present disclosure.

With respect to step S110, for example, the first account may open a program which provides a virtual environment and is adapted to the application virtualization system 102 on the local terminal, so as to interact with the application virtualization system 102, to open the CAD application deployed in the application virtualization system 102 and open a CAD file in the CAD application. In response to the first account clicking on the “check-in” icon provided by the first plug-in in the CAD application, the local terminal may send first import operation information to the server. In response to receiving the first import operation information, the server uses the first plug-in to synchronize the CAD file to the first work subspace.

The first import operation information is, for example, an import request for checking the CAD file generated by the CAD application into the first work subspace, and the first import operation information may include, for example, CAD file identification information, information of the first account, and so on.

For example, the electronic file generated by CAD is stored in a storage medium of the application virtualization system, and in response to receiving the first import operation information, the synchronization server in the server cluster synchronizes the CAD file to the corresponding storage server in the first work subspace.

With respect to step S120, for example, in the case where the second account has first permission to access the first work subspace, the server cluster may receive the first access request from the second account for accessing the CAD file through the first work subspace.

In some embodiments of the present disclosure, for example, in a development project of the first account, the first account, for example, may set the second account as an outsourcing member of the development project in the first work subspace, and then the second account has permission to access the first work subspace.

In some embodiments of the present disclosure, the first account or the second account may log in to the portal website through a browser, so as to send the first access request to the server through the portal website.

For example, in the case where the second account has the first permission to access the first work subspace, then project information related to the second account stored in the first work subspace may be displayed in the second work subspace of the second account, so that the second account may log in to the portal website through a browser, enter its own second work subspace through the portal website, generate the first access request by clicking on the project of the first work subspace displayed in the second work subspace, and send the first access request to the server cluster, so that the server cluster may receive the first access request.

With respect to step S130, in the case where the second account has second permission to access the electronic file, the first access request may be responded to.

In some embodiments of the present disclosure, whether the second account has the second permission may be determined according to the management operation of the first account.

For example, management operation information generated based on that the first account manages permission to access the electronic file may be received, and whether the second account has the second permission is determined according to the management operation information.

For example, the first account creates a CAD file in the first work subspace, and the first account performs a management operation on the CAD file, then management operation information generated according to the management operation is received, so as to determine whether the second account has the second permission according to the management operation information.

For example, the second account is an outsourcing member of the first account with respect to a certain development project. In response to receiving sharing operation information of the first account, it is determined that the second account has the second permission. The sharing operation information may include, for example, sharing an electronic file to a target account, and the target account may be, for example, the second account, or may be all outsourcing members, etc.

For another example, the sharing operation is not executed after the first account uses the CAD application to generate the CAD file, then the server cluster may not receive the sharing operation information, so the second account does not have the second permission.

Hereinafter, the information processing method described above according to FIG. 1A is further explained with reference to FIG. 1C.

FIG. 1C illustrates a schematic diagram of the information processing method provided by at least one embodiment of the present disclosure.

As illustrated in FIG. 1C, the server cluster includes an enterprise A work space (i.e., the first work subspace) 121 created for enterprise A members and an enterprise B work space (i.e., the second work subspace) 131 created for enterprise B members.

For example, a person in charge of the first development project of the enterprise A may set the enterprise B members as outsourcing members of the first development project, and then the enterprise B members have permission to access the enterprise A work space 121. Now that the enterprise B members have the permission to access the enterprise A work space 121, the enterprise B work space 131 may display related information about the first development project. The related information may include, for example, electronic files related to the first development project, a scale of the first development project, participants, and other information.

For example, after Zhang San, a member of the first development project in the enterprise A, enters the enterprise A work space 121, operates the electronic file by using the design application 112 provided by the application virtualization system, and clicks on the “check-in” icon after the operation is completed, the server cluster may execute step 5110, that is, synchronizing the electronic file generated by the design application 112 to the enterprise A work space 121 by using the first plug-in 1121, in response to receiving the first import operation information generated by clicking on the “check-in” icon, that is, executing the first check-in operation illustrated in FIG. 1C, so as to check the electronic file from the storage medium of the application virtualization system 102 to the storage server corresponding to the enterprise A work space 121.

In the case where Zhang San performs a management operation on the permission to access the electronic file, for example, Zhang San shares the electronic file with the outsourcing member of the first development project, then the enterprise B member has the second permission to access the electronic file.

For example, the second account in the enterprise B may enter the enterprise B work space 131 and request to acquire the electronic file in the enterprise B work space 131. Then, in response to the second account having the first permission to access the enterprise A work space 121, the first access request from the second account for accessing the electronic file through the enterprise A work space 121 is received, and response is made to the first access request in response to the second account having the second permission to access the electronic file. For example, the step S120 and the step S130 described above with reference to FIG. 1A may be executed.

FIG. 2A illustrates a flow chart of step S130 in FIG. 1A provided by at least one embodiment of the present disclosure.

As illustrated in FIG. 2A, step S130 may include step S131 and step S132.

Step S131: in response to the second account having the second permission to access the electronic file, activating the design application through the application virtualization system.

Step S132: synchronizing the electronic file from the first work subspace to the design application by using the first plug-in, so that the second account opens the electronic file through the design application and operates the electronic file.

In this embodiment, the first access request in step S120 may be, for example, used to request for opening the electronic file so as to perform operations on the electronic file, for example, editing, modifying, etc.

With respect to step S131, for example, the application virtualization system may interact with a program that runs on the local terminal of the second account adapted to the application virtualization system and used to provide a virtual environment, so that the local terminal of the second account activates the design application deployed in the application virtualization system.

With respect to step S132, for example, in the above-described scenario illustrated in FIG. 1C, the first plug-in may be used to synchronize the electronic file from the enterprise A work space 121 to the design application, that is, the first check-out operation illustrated in FIG. 1C is executed, and the electronic file can be checked out from the enterprise A work space 121 to the design application 112. In this way, the local terminal of the second account may open the electronic file through the design application 112 provided by the application virtualization system 102, and can operate the electronic file.

In some other embodiments of the present disclosure, a first account virtualization subsystem is further deployed in the application virtualization system, the first account virtualization subsystem includes a first management application of the first account with respect to the design application, and the design application also includes a first management plug-in with respect to the first account. Based on the foregoing embodiments, the method may further include: in response to receiving first synchronization operation information, synchronizing the electronic file generated by the design application to the first management application by using the first management plug-in. Hereinafter, these embodiments are described with reference to FIG. 2B.

FIG. 2B illustrates a schematic diagram of another information processing method provided by at least one embodiment of the present disclosure.

As illustrated in FIG. 2B, a first account virtualization subsystem is further deployed in the application virtualization system. The first account virtualization subsystem may be, for example, a virtualization subsystem 122 customized by the enterprise A. The virtualization subsystem 122 customized by the enterprise A may include, for example, a first management application PLM1 of the first account with respect to the design application, for example, the CAD application. The design application, for example, the CAD application, also includes a PLM1 plug-in 1122 with respect to the first account. The PLM1 plug-in 1122 may interact with the PLM1 in the virtualization subsystem 122 customized by the enterprise A.

Of course, the design application may also include a management application plug-in such as a PLM2 plug-in 1123 of any other enterprise such as the enterprise B.

The first synchronization operation information may be generated, for example, as the first account executes an operation to store into the PLM1 in the CAD application. For example, the first account clicks on an option of “store to PLM1 ” in the CAD program, thereby generating the first synchronization operation information.

As illustrated in FIG. 2B, for example, in response to receiving the first synchronization operation information, the PLM1 plug-in 1122 may be used to interact with PLM1, so as to execute the third check-in operation as illustrated in FIG. 2B, that is, to synchronize the electronic file generated by the design application to the first management application PLM1.

As illustrated in FIG. 2B, a second account virtualization subsystem is further deployed in the application virtualization system. The second account virtualization subsystem may be, for example, a virtualization subsystem 123 customized by the enterprise B. The virtualization subsystem 123 customized by the enterprise B may include a second management application PLM2 of the second account with respect to the design application, for example, the CAD application. The design application 112, for example, the CAD application, also includes a PLM2 plug-in 1123 with respect to the second account. The PLM2 plug-in 1123 may interact with the PLM2 in the virtualization subsystem customized by the enterprise B. The information processing method may further include: synchronizing the electronic file opened by the second account to the second management application by using the second management plug-in in response to receiving second synchronization operation information.

The second synchronization operation information may be generated, for example, as the second account executes an operation to store into the PLM2 in the design application 112. For example, the second account clicks on an option of “store to PLM2” in the CAD program, thereby generating the second synchronization operation information.

For example, the second account as one of the members of the enterprise B is an outsourcing member of the first development project of the enterprise A, and then the second account can enter the enterprise B work space 131 to review the electronic file shared by the members of the first development project. The second account, for example, may request to open a certain CAD file among the electronic files. After the CAD file is opened, the second account may click on the option of “store to PLM2” to generate the second synchronization operation information. In response to receiving the second synchronization operation information, the server cluster uses the PLM2 plug-in 1123 to interact with PLM2, so as to execute the fourth check-in operation illustrated in FIG. 2B, that is, to synchronize the CAD file generated by the design application 112 to the second management application PLM2.

By customizing enterprise-specific customized virtualization subsystems (e.g., the enterprise-A-customized virtualization subsystem and the enterprise-B-customized virtualization subsystem) for different users or enterprises in the application virtualization environment, internal data of the enterprise may be isolated from data shared with other users, so that online collaboration between different enterprises or different users may be implemented, while ensuring security of the internal data of the enterprises.

It should be understood that, in this disclosure, the embodiments of the present disclosure are all described by taking that the first account is an account among the enterprise A members, the first work subspace is the enterprise A work space, the second account is an account among the enterprise B members, the second work subspace is the enterprise B work space, and the second account accesses the electronic file in the enterprise A through the first work subspace as an example, but this does not mean that the embodiments of the present disclosure are only applicable to two accounts, and the embodiments of the present disclosure may be applied to any number of accounts. Any account may be used as the first account, and any account may also be used as the second account.

FIG. 3 illustrates a flow chart of another information processing method provided by at least one embodiment of the present disclosure.

As illustrated in FIG. 3, the information processing method may further include step S310 on the basis of the foregoing embodiments. This step, for example, may be executed before step S110 with reference to FIG. 1A.

Step S310: in response to receiving first export operation information performed by the first account on the design application, synchronizing the electronic file from the first management application to the design application by using the first management plug-in.

This method may implement synchronizing the electronic file in the first management application to the design application, so that the electronic file may be further synchronized from the design application to the first work subspace, thereby allowing other accounts to access the electronic file in the first management application through the first work subspace.

With respect to step S310, for example, the first account may perform an export operation in the design application to generate the first export operation information. The export operation may be, for example, that the first account clicks on the “check out” button provided by the design application. In response to receiving the first export operation information, the server cluster uses the first management plug-in to synchronize the electronic file from the first management application to the design application.

As illustrated in FIG. 2B, for example, the first account selects a certain electronic file in the design application 112 and clicks on the “check-out” icon with respect to the file, so as to generate the first export operation information. In response to the first export operation information, the server cluster uses the PLM1 plug-in 1122 to interact with the PLM1, so as to execute the third check-out operation illustrated in FIG. 2B, that is, to check out the CAD file from the PLM1 to the CAD application. Similarly, the second account may also enter its own second work subspace, access the electronic file in the project created by the second account itself, and then click on the “check-out” icon to generate the first export operation information. The server cluster uses the PLM2 plug-in 1123 to interact with the PLM2, so as to execute the fourth check-out operation illustrated in FIG. 2B, that is, to check out the CAD file from the PLM2 to the CAD application, so as to open the CAD file.

FIG. 4 illustrates a flow chart of another information processing method provided by at least one embodiment of the present disclosure.

As illustrated in FIG. 4, the information processing method may further include step S410 on the basis of the foregoing embodiments. The step S410, for example, may be executed after the step S130.

Step S410: in response to receiving second import operation information, synchronizing the electronic file to the second work subspace by using the first plug-in, so that the second work subspace includes the electronic file that is operated.

For example, in response to receiving the second import operation information, the second check-in operation illustrated in FIG. 2B is executed, that is, the first plug-in 1121 synchronizes the electronic file to the enterprise B work space 131.

For example, the second account opens a CAD file in a CAD application, and when the second account clicks on a “check-in” icon after editing the CAD file, the server cluster may send a pop-up window to the local terminal of the second account. A “new” icon, an “assign” icon and a “save” icon may be included in the pop-up window, for example.

In the case where the second account selects the “new” icon, the edited CAD file is saved in a default work space. After that, in the case where the user re-executes an operation of moving the edited CAD file to the second work subspace, the second import operation information can be generated, thereby using the first plug-in 1121 to synchronize the CAD file to the enterprise B work space 131. As illustrated in FIG. 2B, in response to receiving the second import operation information, the first plug-in 1121 can be utilized to synchronize the CAD electronic file to the enterprise B work space 131.

In the case where the user selects the “assign” icon, and selects the assigned target space as the second work subspace, the second import operation information can be generated, thereby using the first plug-in to synchronize the CAD file to the second work subspace. As illustrated in FIG. 2B, in response to receiving the second import operation information, the first plug-in 1121 can be utilized to synchronize the CAD electronic file to the enterprise B work space 131.

In some other embodiments of the present disclosure, in the case where the user selects the “save” icon, the CAD file is saved to an original position. For example, in the case where the second account opens a CAD file in the enterprise A work space 121, the CAD file in the enterprise A work space 121 is updated to be the edited CAD file.

In some other embodiments of the present disclosure, for example, the second account opens an electronic file in the design application 112, but the second account clicks on the “check-in” icon without editing the electronic file, and thus the server cluster can directly save the electronic file to an original position. That is, in the case where the second account opens the CAD file in the enterprise A work space, the CAD file is still saved in the enterprise A work space. Alternatively, even if the second account clicks on the “check in” icon without editing the electronic file, a pop-up window can also be sent to the local terminal of the second account. A “new” icon, an “assign” icon and a “save” icon may be included in the pop-up window, for example, and specific operations are as described above, which will not be repeated here.

In some other embodiments of the present disclosure, the enterprise B member can check out an electronic file in the enterprise B work space to the design application 112 through the first plug-in 1121. For example, the enterprise B member enters the enterprise B work space, and a development project created by the enterprise B is included in the enterprise B work space.

FIG. 5A illustrates another server cluster 500 to which the information processing method provided by at least one embodiment of the present disclosure may be applied.

As illustrated in FIG. 5A, the portal website of the server cluster 500 may further include an application center 102 in addition to the work space 101.

The first account or the second account sends a second access request to the server cluster through the application center 102. For example, after the first account or the second account logs in to the portal website through a browser 501, an application icon provided by the application center 102 can be clicked on, so as to send the second access request to the server cluster 500.

In some embodiments of the present disclosure, application icons provided by the application center 102 can be divided into two groups. Application icons in a first group are icons of applications in a shared virtualization subsystem, and application icons in a second group can be icons of applications in a user-customized virtualization subsystem (for example, the enterprise-A-customized virtualization subsystem and the enterprise-B-customized virtualization subsystem). For example, the first account or the second account logs in to the portal website through the browser 501, enters the application center 102 in the portal website, and selects an icon of a certain application in the application center 102, thereby generating the second access request. In response to that the second access request is generated, an application virtualization system client 502 is started, thereby sending the second access request to the server cluster 500 through the application virtualization system client 502.

In another embodiment of the present disclosure, the second access request may also be sent to the server cluster 500 through the browser rather than the application virtualization system client 502, so that the server cluster 500 responds to the second access request.

In the case where the server cluster 500 receives the second access request, the information processing method illustrated in FIG. 5B can be executed.

As illustrated in FIG. 5A, the portal website may further include a console 103, and the console, for example, can be opened for use by an administrator, so that the administrator can authorize different users to use different applications in the application center, thereby realizing that different enterprises use different applications, and exclusive virtualization subsystems are customized for the enterprises.

FIG. 5B illustrates a flow chart of another information processing method provided by at least one embodiment of the present disclosure.

As illustrated in FIG. 5B, the information processing method may further include steps S510-S530 on the basis of the foregoing embodiments. The steps S510-S530, for example, can be executed before the step S110.

Step S510: in response to receiving the second access request generated through the portal website, verifying identity information, in which the second access request includes the identity information.

As illustrated in FIG. 5A, application virtualization system middleware 110 may also be deployed on the server cluster 500. For example, the application virtualization system middleware 110 receives the second access request generated through the portal website. The second access request, for example, includes the identity information, and the identity information may include account information, device information of a user local terminal, etc.

As illustrated in FIG. 5B, the application virtualization system middleware 110 may include an identity verifying module 1101 and a request distributing module 1102.

The identity information is verified through the identity verifying module 1101, and for example, the legitimacy of the identity can be verified.

Step S520: in the case where the identity information included in the second access request is verified, determining a virtualization subsystem to which the second access request is distributed according to the identity information, in which the virtualization subsystem includes the first account virtualization subsystem, the second account virtualization subsystem or the shared virtualization subsystem.

For example, in the case where it is determined through identity verification that the identity information in the second access request is matched with that of the first account, the identity information is verified, and it can be determined that the second access request comes from the first account.

In the case where the access request is generated by the first account as one of enterprise A members based on the operation that the first account selects the application icons in the above-mentioned second group (for example, application icons in the enterprise-A-customized virtualization subsystem), the request distributing module 1102 may determine that the second access request is distributed into an enterprise-A-customized virtualization subsystem 122.

In the case where the access request is generated by the first account based on the operation that the first account selects the application icons in the above-mentioned first group (for example, icons of applications in the shared virtualization subsystem), the request distributing module 1102 may determine that the second access request is distributed into a shared virtualization subsystem 124.

Step S530: distributing the second access request to one of the first account virtualization subsystem, the second account virtualization subsystem, or the shared virtualization subsystem.

For example, the request distributing module 1102 can distribute the second access request to one of the first account virtualization subsystem, the second account virtualization subsystem, or the shared virtualization subsystem.

In some embodiments of the present disclosure, the shared virtualization subsystem and the user-customized virtualization subsystem may respectively include a virtual application assistant, so that the virtual application assistant launches a response thread according to parameters in the first access request or the second access request. The response thread, for example, may use an agent program of an application to start the application in an application pool, and return a started application into an application work interface of a user's local terminal. The application, for example, may be a design application or may be a management application.

In another embodiment of the present disclosure, the information processing method may further include: in response to receiving the first access request generated through the portal website, verifying the identity information, the first access request including the identity information; in the case where the identity information included in the first access request is verified, forwarding the first access request to the shared virtualization subsystem according to the identity information; and responding to the first access request by the virtual application assistant.

The first access request, for example, can be generated by the first account or the second account described above based on the operation that the first account or the second account enters the work space and clicks on a certain electronic file in the work space. The first access request, for example, can be the request described above with reference to step S120 in FIG. 1A, which is not repeated here.

In response to receiving the first access request, the identity information is verified, and for example, the verification may be executed according to the step S510 described above with reference to FIG. 5B, that is, the identity verifying module 1101 in the application virtualization system middleware 110 is utilized to verify the identity information, which is not repeated here.

Because the first access request is generated by operating the electronic file in the work space, the request distributing module 1102 in the application virtualization system middleware 110 can distribute the first access request to the shared virtualization subsystem, and the virtual application assistant in the shared virtualization subsystem launches the response thread.

FIG. 5C illustrates a flow chart of another information processing method provided by at least one embodiment of the present disclosure.

As illustrated in FIG. 5C, the information processing method may further include steps S540-S560 on the basis of the foregoing embodiments. The steps S540-S560, for example, may be executed before the step S110.

Step S540: in response to receiving a creation request for creating a task in the first work subspace, creating the task in the first work subspace.

For example, the first account can enter the enterprise A work space, and the task can be created in the enterprise A work space by the first account. The server cluster responds to the creation request, and the task is created in the enterprise A work space, i.e., the first work subspace. For example, the task may refer to a project created in the work space.

Step S550: receiving member permission information, so as to manage the access permission of a member in the task to access the first work subspace or to access the electronic file of the task.

Step S560: determining whether the second account has permission to access the first work subspace according to the member permission information.

For example, information from a member of the first account of the enterprise A member setting an enterprise B member as the collaborative personnel of a first development project can be received, so as to determine that the collaborative developer of the enterprise B has the permission to access the first development project.

FIG. 6 illustrates a flow chart of another information processing method provided by at least one embodiment of the present disclosure.

As illustrated in FIG. 6, the information processing method may include steps S610-S630.

Step S610: in response to receiving third synchronization operation information performed by the first account in the first work subspace, synchronizing the electronic file from the first management application to the first work subspace

Step S620: in response to the second account having first permission to access the first work subspace, receiving a first access request from the second account to access the electronic file through the first work subspace.

Step S630: responding to the first access request in response to the second account having second permission to access the electronic file.

In this embodiment, work space and an application virtualization system are deployed on the server. The application virtualization system includes a first account virtualization subsystem, the first account virtualization subsystem at least includes a first management application, and the first management application includes a first management application adaptor and stores an electronic file. The work space includes an interface program and first work subspace, and the work space includes a functional module that is used to manage the electronic file generated based on a design application.

The information processing method can synchronize an electronic file of the first account to the first work subspace through direct interaction between the first work subspace and the first management application of the first account without using the design application, and therefore, the second account can access the electronic file.

The information processing method described above with reference to FIG. 6 is explained below in conjunction with FIG. 7. FIG. 7 illustrates a schematic diagram of another information processing method provided by at least one embodiment of the present disclosure.

As illustrated in FIG. 7, work space 101 and an application virtualization system 102 are deployed on a server, and the application virtualization system 102 includes a first account virtualization subsystem. The first account virtualization subsystem, for example, may be an enterprise-A-customized virtualization subsystem 122, the first account virtualization subsystem at least includes a first management application, for example, PLM1, and the first management application such as PLM1 includes a first management application adaptor 1221 and stores an electronic file. The work space 101 includes an interface program 161 and first work subspace. The first work subspace may be, for example, an enterprise A work space 121. The work space includes a functional module that is used to manage an electronic file generated based on a design application, and the work space, for example, may include the functional modules of PLM.

For step S610, for example, a first account of an enterprise A member performs a third synchronization operation in the first work subspace, thereby generating the third synchronization operation information. For example, the third synchronization operation is used for requesting to synchronize the electronic file in the PLM1 into the enterprise A work space.

In response to receiving the third synchronization operation information, the sever cluster may operate the third synchronization operation, as illustrated in FIG. 7. That is, the electronic file is synchronized into the first work subspace 121 from the first management application 122 through the PLM1 adaptor 1221 via the interface program 161.

For the step S620, in some embodiments of the present disclosure, for example, the first account can manage member permission information according to the method described above with reference to FIG. 5C, thereby determining whether the second account has permission to access the first work subspace according to the member permission information. For example, in a development project of the first account, the first account, for example, can set the second account as a collaborative member of the development project in the first work subspace, and then the second account has the permission to access the first work subspace.

In some embodiments of the present disclosure, the first account or the second account may log in to a portal website through a browser, so as to send the first access request to the server through the portal website.

For example, in the case where the second account has the first permission to access the first work subspace, the electronic file related to the second account stored in the first work subspace can be displayed in the second work subspace of the second account, and thus, the second account can log in to the portal website through the browser, enter the second work subspace through the portal website, generate the first access request by clicking on the electronic file in the second work subspace, and send the first access request to the server cluster, so that the server cluster can receive the first access request.

The step S620 is similar to the step S120 described above with reference to FIG. 1A, which is not repeated here.

In an embodiment of the present disclosure, the application virtualization system further includes a second account virtualization subsystem. The second account virtualization subsystem, for example, may be an enterprise-B-customized virtualization subsystem. The second account virtualization subsystem at least includes a second management application, for example, PLM2, and the second management application includes a second management application adaptor 1231. The first access request, for example, may be a first request used for synchronizing the electronic file to the second work subspace from the first work subspace, and step S630 may include: synchronizing the electronic file to the second work subspace through the interface program and the second management application adaptor, in response to the second account having the second permission to access the electronic file.

As illustrated in FIG. 7, in response to the second account having the second permission to access the electronic file, a fourth synchronization operation can be executed, that is, the electronic file is synchronized to an enterprise-B-customized virtualization subsystem 123 through the interface program 161 via the second adaptor of PLM2.

In some embodiments of the present disclosure, whether the second account has the second permission may be determined according to a management operation of the first account.

For example, the management operation information generated based on the operation that the first account manages the access permission of the electronic file can be received, and whether the second account has the second permission is determined according to the management operation information.

For example, the first account creates a CAD file in the first work subspace, and the first account performs a management operation on the CAD file, and then the management operation information generated according to the management operation is received, so as to determine whether the second account has the second permission according to the management operation information.

For example, the second account is a collaborative member of the first account with respect to a certain development project, and in response to receiving sharing operation information of the first account, it is determined that the second account has the second permission. The sharing operation information may include, for example, sharing the electrode file to a target account, and the target account may be, for example, the second account, or may be all collaborative members, etc.

For another example, after the first account utilizes the CAD application to generate the CAD file, the sharing operation is not executed, and then the server cluster may not receive the sharing operation information, so the second account does not have the second permission.

In another embodiment of the present disclosure, a design application is deployed in the application virtualization system, the design application includes a first plug-in, and the first access request further includes a second request used for opening the electronic file so as to operate the electronic file. The step S630 may further include: in response to the second account having the second permission to access the electronic file, activating the design application through the application virtualization system; and synchronizing the electronic file to the design application from the first work subspace by using the first plug-in, so that the second account opens the electronic file through the design application and operates the electronic file.

In this embodiment, the first plug-in is deployed in the design application, so that the second account can open the electronic file through the first work subspace of the first account, and the electronic file can be synchronized to the design application from the first work subspace through the first plug-in. While realizing the direct interaction between the first work subspace and the first management application of the first account without through the design application, the method also realizes the effect that the second account can utilize the first plug-in to operate the electronic file of the first work subspace online.

It should be illustrated that, the interaction process between the server cluster and the user local terminal and the interaction method within the server cluster described above with reference to FIG. 5A, FIG. 5B and FIG. 5C are still applicable to the information processing method described above with reference to FIG. 6 and FIG. 7, which may not be repeated here.

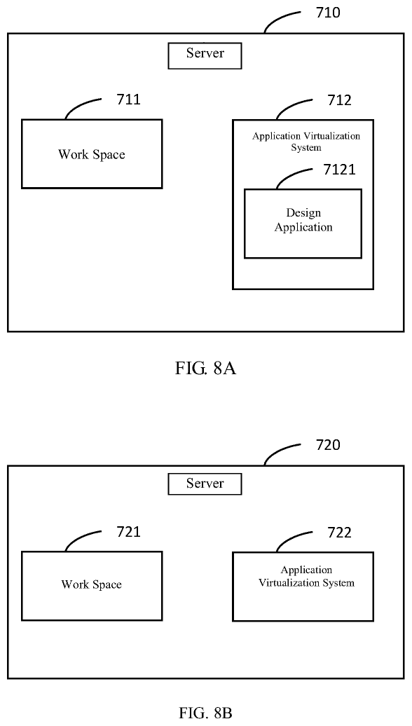

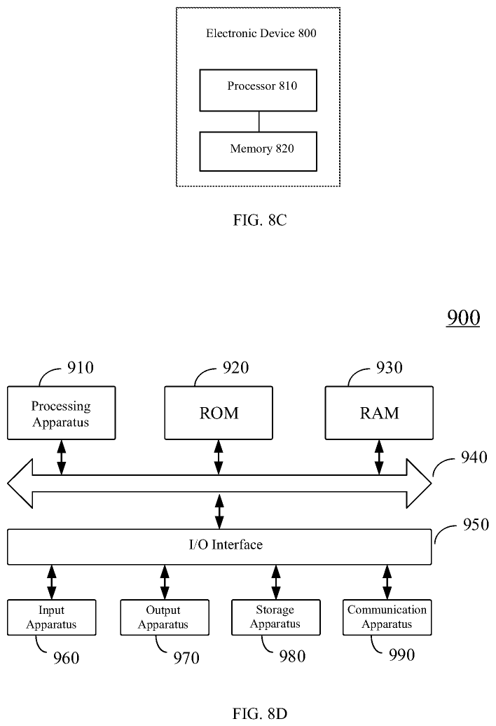

Some other embodiments of the present disclosure provide an information processing system. FIG. 8A illustrates a schematic block diagram of an information processing system provided by at least one embodiment of the present disclosure.

As illustrated in FIG. 8A, the information processing system may include a server 710, and work space 711 and an application virtualization system 712 are deployed in the server 710. A design application 7121 is deployed in the application virtualization system 712, and the design application 7121 includes a first plug-in.

The work space 711 at least includes first work subspace created for a first account. The work space 711 includes a functional module that manages an electronic file generated based on the design application.

The first work subspace is configured to receive a first access request from a second account to access the electronic file through the first work subspace, in response to the second account having the first permission to access the first work subspace.

The design application is configured to receive first import operation information performed by the first account on the design application, and respond to the first access request in response to the second account having the second permission to access the electronic file.

The first plug-in is configured to synchronize the electronic file generated by the design application to the first work subspace.

The information processing system can implement the information processing method provided by the embodiments of the present disclosure. For example, the information processing method can be the method described in FIGS. 1A-1C, FIGS. 2A-2B, FIGS. 3-4 and FIGS. 5A-5C. The information processing system can allow multiple users to collaborate online, and improve efficiency of collaboration between personnel across organizations and across regions.

Some embodiments of the present disclosure provide another information processing system. FIG. 8B illustrates a schematic block diagram of another information processing system provided by at least one embodiment of the present disclosure.

As illustrated in FIG. 8B, the information processing system may include a server 720, on which work space 721 and an application virtualization system 722 are deployed.

The application virtualization system 722 includes a first account virtualization subsystem, the first account virtualization subsystem at least includes a first management application, and the first management application includes a first management application adaptor and an electronic file.

The work space 721 includes an interface program and first work subspace created for a first account. The work space includes a functional module that manages the electronic file generated based on a design application.

The first management application adaptor is configured to send the electronic file to the interface program in response to receiving third synchronization operation information performed by the first account in the first work subspace.

The interface program is configured to receive the electronic file from the first management application adaptor, so as to synchronize the electronic file to the first work subspace.

The first work subspace is configured to receive a first access request from a second account to access the electronic file through the first work subspace in response to the second account having first permission to access the first work subspace, and respond to the first access request in response to the second account having second permission to access the electronic file.

The information processing system can implement the information processing method provided by the embodiments of the present disclosure. For example, the information processing method may be the method described in FIG. 6 to FIG. 7. The information processing system may allow a plurality of users to collaborate online, and improve efficiency of collaboration between personnel across organizations and across regions.

At least one embodiment of the present disclosure further provides an electronic device, which includes a processor and a memory. The memory includes one or more computer program modules. The one or more computer program modules are stored in the memory and are configured to be executed by the processor. The one or more computer program modules include instructions for implementing the above-described information processing method. The electronic device may allow a plurality of users to collaborate online, and improve efficiency of collaboration between personnel across organizations and across regions.

FIG. 8C is a schematic block diagram of an electronic device provided by some embodiments of the present disclosure. As illustrated in FIG. 8C, an electronic device 800 includes a processor 810 and a memory 820. The memory 820 is configured to store non-transitory computer readable instructions (e.g., one or more computer program modules). The processor 810 is configured to run the non-transitory computer readable instructions, and the non-transitory computer readable instructions may execute one or more steps in the above-described information processing method when executed by the processor 810. The memory 820 and the processor 810 may be interconnected by a bus system and/or other form of connection mechanisms (not illustrated).

For example, the processor 810 may be a central processing unit (CPU), a graphics processing unit (GPU), or any other form of processing unit having a data processing capability and/or a program execution capability. For example, the central processing unit (CPU) may be an X86 or ARM architecture. The processor 810 may be a general-purpose processor or a special-purpose processor, and may control other components in the electronic device 800 to achieve desired functions.

For example, the memory 820 may include any combination of one or more computer program products, and the computer program products may include various forms of computer readable storage media, for example, a volatile memory and/or a non-volatile memory. The volatile memory may include, for example, a random access memory (RAM) and/or a cache, or the like. The non-volatile memory may include, for example, a read only memory (ROM), a hard disk, an erasable programmable read only memory (EPROM), a portable compact disk read only memory (CD-ROM), a USB memory, a flash memory, or the like. One or more computer program modules may be stored on the computer readable storage medium, and the processor 810 may run the one or more computer program modules, so as to implement various functions of the electronic device 800. Various applications and various data, as well as various data used and/or generated by the applications may also be stored in the computer readable storage medium.

It should be noted that, in the embodiments of the present disclosure, for specific functions and technical effects of the electronic device 800, the above description of the information processing method may be referred to, and no detail is repeated here.

FIG. 8D is a schematic block diagram of another electronic device provided by some embodiments of the present disclosure. An electronic device 900 is, for example, suitable for implementing the information processing method provided by the embodiments of the present disclosure. The electronic device 900 may be a terminal device or the like. It should be noted that, the electronic device 900 illustrated in FIG. 8D is only an example, which does not bring any limitation to the functions and the scope of use according to the embodiments of the present disclosure.

As illustrated in FIG. 8D, the electronic device 900 may include a processing apparatus (e.g., a central processing unit, or a graphics processing unit, etc.) 910, and may execute various appropriate actions and processing according to the program stored in a read only memory (ROM) 920 or the program loaded from a storage apparatus 980 to a random access memory (RAM) 930. In the RAM 930, various programs and data required for operations of the electronic device 900 are also stored. The processing apparatus 910, the ROM 920, and the RAM 930 are connected with each other through a bus 940. An input/output (I/O) interface 950 is also coupled to the bus 940.

Usually, the following apparatuses may be coupled to the I/O interface 950: an input apparatus 960 including, for example, a touch screen, a touch pad, a keyboard, a mouse, a camera, a microphone, an accelerometer, a gyroscope, etc.; an output apparatus 970 including, for example, a liquid crystal display (LCD), a speaker, a vibrator, etc.; a storage apparatus 980 including, for example, a magnetic tape, a hard disk, etc.; and a communication apparatus 990. The communication apparatus 990 may allow the electronic device 900 to perform wireless or wired communication with other electronic device to exchange data. Although FIG. 8D illustrates the electronic device 900 having various apparatuses, it should be understood that, it is not required to implement or have all the apparatuses illustrated, and the electronic device 900 may alternatively implement or have more or fewer apparatuses.

For example, according to the embodiments of the present disclosure, the above-described information processing method may be implemented as a computer software program. For example, the embodiments of the present disclosure include a computer program product, which includes a computer program carried on a non-transitory computer readable medium, and the computer program includes program codes for executing the above-described information processing method. In such an embodiment, the computer program may be downloaded and installed from a network through the communication apparatus 990, or installed from the storage apparatus 980, or installed from the ROM 920. When executed by the processing apparatus 910, the computer program may implement the functions defined in the information processing method provided by the embodiments of the present disclosure.

At least one embodiment of the present disclosure further provides a computer readable storage medium, the computer readable storage medium is configured to store non-transitory computer readable instructions, and the non-transitory computer readable instructions can implement the above-described information processing method when executed by a computer. By using the computer readable storage medium, a plurality of users can collaborate online, thereby improving efficiency of collaboration between personnel across organizations and across regions.

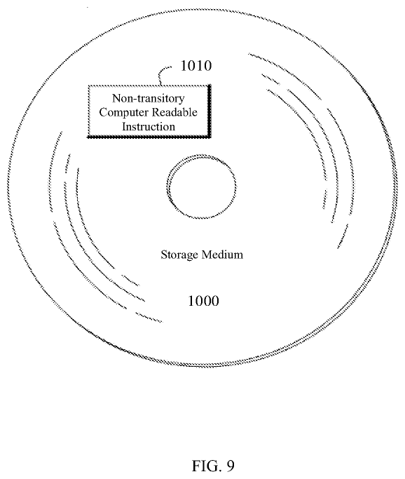

FIG. 9 is a schematic diagram of a storage medium provided by some embodiments of the present disclosure. As illustrated in FIG. 9, a storage medium 1000 is configured to store non-transitory computer readable instructions 1010. For example, the non-transitory computer readable instructions 1010 may execute one or more steps in the above-described information processing method when executed by a computer.

For example, the storage medium 1000 may be applied to the above-described electronic device 800. For example, the storage medium 1000 may be the memory 820 in the electronic device 800 illustrated in FIG. 8C. For example, for related description of the storage medium 1000, corresponding description of the memory 820 in the electronic device 800 illustrated in FIG. 8C may be referred to, and no detail is repeated here.

The following statements should be noted.

(1) The accompanying drawings involve only the structure(s) in connection with the embodiment(s) of the present disclosure, and other structure(s) can be referred to common design(s).

(2) In case of no conflict, features in one embodiment or in different embodiments can be combined to obtain new embodiments.

What have been described above are only specific implementations of the present disclosure, the protection scope of the present disclosure is not limited thereto, and the protection scope of the present disclosure should be based on the protection scope of the claims

1. An information processing method, applied to a server, wherein a work space and an application virtualization system are deployed on the server, a design application is deployed in the application virtualization system, the design application comprises a first plug-in, the work space at least comprises first work subspace, the work space comprises a functional module that manages an electronic file generated based on the design application, and the method comprises:
in response to receiving a first import operation information performed on the design application by a first account, synchronizing the electronic file generated by the design application from the application virtualization system to the first work subspace by using the first plug-in;
in response to a second account having a first permission to access the first work subspace, receiving a first access request from the second account for accessing the electronic file through the first work subspace; and
in response to the second account having second permission to access the electronic file, responding to the first access request.

2. The method according to claim 1, wherein the first access request is used for requesting to open the electronic file so as to operate the electronic file, and
in response to the second account having the second permission to access the electronic file, responding to the first access request, comprises:
in response to the second account having the second permission to access the electronic file, activating the design application through the application virtualization system; and
synchronizing the electronic file from the first work subspace to the design application by using the first plug-in, so that the second account opens the electronic file through the design application and operates the electronic file.

3. The method according to claim 1, wherein a first account virtualization subsystem is deployed in the application virtualization system, the first account virtualization subsystem comprises a first management application of the first account with respect to the design application, the design application further comprises a first management plug-in with respect to the first account, and the method further comprises:
in response to receiving a first synchronization operation information, synchronizing the electronic file generated by the design application to the first management application by using the first management plug-in.

4. The method according to claim 3, wherein a second account virtualization subsystem is deployed in the application virtualization system, the second account virtualization subsystem comprises a second management application with respect to the design application, the design application further comprises a second management plug-in with respect to the second account, and the method further comprises:
in response to receiving a second synchronization operation information, synchronizing the electronic file opened by the second account to the second management application by using the second management plug-in.

5. The method according to claim 3, wherein the first management application stores the electronic file, and the method further comprises:
in response to receiving a first export operation information performed by the first account on the design application, synchronizing the electronic file in the first management application to the design application by using the first management plug-in.

6. The method according to claim 2, wherein the work space further comprises a second work subspace, and the method further comprises:
in response to receiving a second import operation information, synchronizing the electronic file to the second work subspace by using the first plug-in, so that the second work subspace comprises the electronic file that is operated.

7. The method according to claim 3, wherein a portal website is deployed on the server, and
the first account or the second account is capable of logging in to the portal website through a browser, so as to send the first access request to the server through the portal website.

8. The method according to claim 7, wherein the portal website comprises an application center, the first account or the second account is capable of sending a second access request to the server through the application center, the application virtualization system comprises a shared virtualization subsystem, the shared virtualization subsystem comprises the design application, and the method further comprises:
verifying identity information in response to receiving the second access request generated through the portal website, the second access request comprising the identity information;
in a case where the identity information comprised in the second access request is verified, determining a virtualization subsystem to which the second access request is distributed according to the identity information, the virtualization subsystem comprising the first account virtualization subsystem, the second account virtualization subsystem, or the shared virtualization subsystem; and
distributing the second access request to one of the first account virtualization subsystem, the second account virtualization subsystem, or the shared virtualization subsystem.

9. The method according to claim 8, wherein the shared virtualization subsystem comprises a virtual application assistant, and the method further comprises:
verifying the identity information in response to receiving the first access request generated through the portal website, the first access request comprising the identity information;
in a case where the identity information comprised in the first access request is verified, forwarding the first access request to the shared virtualization subsystem according to the identity information; and
responding, by the virtual application assistant, to the first access request.

10. The method according to claim 1, further comprising:
in response to receiving a creation request for creating a task in the first work subspace, creating the task in the first work subspace;
receiving member permission information, so as to manage access permission of a member in the task to access the first work subspace or to access the electronic file of the task; and
determining whether the second account has permission to access the first work subspace according to the member permission information.

11. The method according to claim 1, further comprising:
receiving management operation information generated based on that the first account manages permission to access the electronic file; and
determining whether the second account has the second permission according to the management operation information.

12. An information processing method, applied to a server, wherein work space and an application virtualization system are deployed on the server, the application virtualization system comprises a first account virtualization subsystem, the first account virtualization subsystem at least comprises a first management application, the first management application comprises a first management application adaptor and stores an electronic file, the work space comprises an interface program and first work subspace, the work space comprises a functional module that manages the electronic file generated based on a design application, and the method comprises:
in response to receiving third synchronization operation information performed by a first account in the first work subspace, synchronizing the electronic file from the first management application to the first work subspace through the first management application adaptor via the interface program;
in response to a second account having first permission to access the first work subspace, receiving a first access request from the second account to access the electronic file through the first work subspace; and
in response to the second account having second permission to access the electronic file, responding to the first access request.

13. The method according to claim 12, wherein the application virtualization system further comprises a second account virtualization subsystem, the second account virtualization subsystem at least comprises a second management application, the second management application comprises a second management application adaptor, and the work space further comprises second work subspace,
the first access request comprises a first request for synchronizing the electronic file from the first work subspace to the second work subspace, and
in response to the second account having the second permission to access the electronic file, responding to the first access request, comprises:
in response to the second account having the second permission to access the electronic file, synchronizing the electronic file to the second work subspace through the interface program and the second management application adaptor.

14. The method according to claim 13, wherein a design application is deployed in the application virtualization system, the design application comprises a first plug-in, and the first access request further comprises a second request for opening the electronic file so as to operate the electronic file, and in response to the second account having the second permission to access the electronic file, responding to the first access request, comprises:
in response to the second account having the second permission to access the electronic file, activating the design application through the application virtualization system; and
synchronizing the electronic file from the first work subspace to the design application by using the first plug-in, so that the second account opens the electronic file through the design application and operates the electronic file.

15. The method according to claim 14, wherein a portal website is deployed on the server, and
the first account or the second account is capable of logging in to the portal website through a browser, so as to send the first access request to the server through the portal website.

16. The method according to claim 15, wherein the portal website comprises an application center, the first account or the second account is capable of sending a second access request to the server through the application center, and the method further comprises:
receiving the second access request from the portal website, the second access request comprising identity information;
verifying the identity information;
in a case where the identity information is verified, determining a virtualization subsystem to which the second access request is distributed according to the identity information, the virtualization subsystem comprising the first account virtualization subsystem or the second account virtualization subsystem; and
distributing the second access request to the first account virtualization subsystem or the second account virtualization subsystem.

17. The method according to claim 15, wherein the application virtualization system comprises a shared virtualization subsystem, the shared virtualization subsystem comprises the design application and a virtual application assistant, and the method further comprises:
receiving the first access request from the portal website, the first access request comprising identity information;
verifying the identity information;
in a case where the identity information is verified, forwarding the first access request to the shared virtualization subsystem according to the identity information; and
activating, by the virtual application assistant, the design application.

18. The method according to claim 12, further comprising:
in response to receiving a creation request for creating a task in the first work subspace, creating the task in the first work subspace;
receiving member permission information so as to manage permission of members in the task to access the first work subspace or to access the electronic file of the task; and
determining whether the second account has permission to access the first work subspace according to the member permission information.

19. The method according to claim 12, further comprising:
receiving management operation information generated based on that the first account manages permission to access the electronic file; and
determining whether the second account has the second permission according to the management operation information.

20. An information processing system, comprising a server computer, wherein work space and an application virtualization system are deployed on the server computer, a design application is deployed in the application virtualization system, the design application comprises a first plug-in, the work space at least comprises first work subspace created for a first account, and the work space comprises a functional module that manages an electronic file generated based on the design application,
the first work subspace is configured to, in response to a second account having first permission to access the first work subspace, receive a first access request from the second account for accessing the electronic file through the first work subspace;
the design application is configured to receive first import operation information performed by the first account on the design application, and respond to the first access request in response to the second account having second permission to access the electronic file; and
the first plug-in is configured to synchronize the electronic file generated by the design application from the application virtualization system to the first work subspace.

21. An information processing system, comprising a server computer, wherein work space and an application virtualization system are deployed on the server computer, the application virtualization system comprises a first account virtualization subsystem, the first account virtualization subsystem at least comprises a first management application, the first management application comprises a first management application adaptor and an electronic file, the work space comprises an interface program and first work subspace created for a first account, and the work space comprises a functional module that manages the electronic file generated based on the design application,
the first management application adaptor is configured to send the electronic file to the interface program in response to receiving third synchronization operation information performed by the first account in the first work subspace;
the interface program is configured to receive the electronic file sent from the first management application adaptor, so as to synchronize the electronic file to the first work subspace; and
the first work subspace is configured to receive a first access request from a second account to access the electronic file through the first work subspace in response to the second account having first permission to access the first work subspace, and respond to the first access request in response to the second account having second permission to access the electronic file.

22. An electronic device, comprising:
a processor;
a memory, comprising one or more computer program modules,
wherein the one or more computer program modules are stored in the memory and configured to be executed by the processor, and the one or more computer program modules comprise instructions for implementing the information processing method according to claim 1.

23. A computer readable storage medium, for storing non-transitory computer readable instructions, which are configured to be executed by a computer to implement the information processing method according to claim 1.
